(19) United States
(12) Patent Application Publication
(10) Pub. No.: US 2015/0306818 A1
(43) Pub. Date: Oct. 29, 2015

(54) THREE-DIMENSIONAL PRINTER AND A THREE-DIMENSIONAL PRINTING MODULE THEREOF

(71) Applicants: XYZPRINTING, INC., New Taipei City (TW); KINPO ELECTRONICS, INC., New Taipei City (TW); CAL-COMP ELECTRONICS & COMMUNICATIONS COMPANY LIMITED, New Taipei City (TW)

(72) Inventors: Peng-Yang Chen, New Taipei City (TW); Wen-Ten Lin, New Taipei City (TW)

(21) Appl. No.: 14/559,863

(22) Filed: Dec. 3, 2014

(30) Foreign Application Priority Data
Apr. 24, 2014 (TW) 103114857

(51) Int. Cl. B29C 67/00

(52) U.S. Cl. CPC B29C 67/0074; B29L 2009/00

(57) ABSTRACT

A three-dimensional printing module includes a base seat, a sintering mechanism, a coloring mechanism and a forming mechanism. The base seat is movable relative to a powder layer. The sintering mechanism is mounted to the base seat for selectively sintering the powder layer to form a sintered layer. The coloring mechanism is mounted to the base seat, and is movable in a second direction relative to the base seat for selectively coloring the sintered layer to form a sintered and colored layer. The forming mechanism is mounted to the base seat for flattening the sintered and colored layer to form a solid layer.

### CROSS-REFERENCE TO RELATED APPLICATION

This application claims priority of Taiwanese Application No. 103114857, filed on Apr. 24, 2014.

### BACKGROUND OF THE INVENTION

1. Field of the Invention

The invention relates to a three-dimensional printer, more particularly to a multi-color three-dimensional printer.

2. Description of the Related Art

Recently, since three-dimensional rapid prototyping (three-dimensional printing) techniques become more and more mature, they are applied in extensive fields, and have a considerable business value.

Among conventional three-dimensional rapid prototyping machines, three-dimensional printers that utilize selective heat sintering (SHS) technology are suitable for rapid prototyping of thermoplastic powder, such as polylactic acid (PLA) or acrylonitrile butadiene styrene (ABS), and are preferred by consumers. In selective heat sintering technology, a thermoplastic powder layer is first laid. Then the thermoplastic powder layer is selectively sintered to form a solid model of one of a series of successive cross-sections of a three-dimensional CAD (computer aided design) model. By performing the laying and sintering operations of thermoplastic powder layers repeatedly, a solid model of the three-dimensional CAD model is formed.

However, a solid model made by a conventional three-dimensional printer that utilizes selective heat sintering technology is monochromic and has a color the same to that of the thermoplastic powder. To make a multi-color solid model, dyes having different colors are applied on the solid model after the sintered solid model is cooled down, or thermoplastic powders having different colors are used to form the thermoplastic powder layers. However, it is difficult to control precisely boundaries of the regions to be colored when applying dyes to the whole solid model of the CAD model, and the cooled-down solid model is inferior to absorb the dyes. Moreover, to lay thermoplastic powders having different colors to form a colored powder layer, the structure of a laying mechanism of the conventional three-dimensional printer must be more complicated.

### SUMMARY OF THE INVENTION

Therefore, one object of the present invention is to provide a three-dimensional printing module that can overcome the aforesaid drawbacks associated with the prior arts.

Accordingly, one type of a three-dimensional printing module of the present invention is adapted to be disposed on a machine body of a three-dimensional printer. The three-dimensional printer permits a powder layer to be fed thereon. The three-dimensional printing module includes a base seat, a sintering mechanism, a coloring mechanism and a forming mechanism. The base seat is adapted to be movable in a first direction relative to the powder layer. The sintering mechanism is mounted to the base seat and is adapted to selectively sinter the powder layer to form a sintered layer. The coloring mechanism is mounted to the base seat, is movable in a second direction relative to the base seat, and is adapted to selectively color the sintered layer to form a sintered and colored layer. The forming mechanism is mounted to the base seat and is adapted to flatten the sintered and colored layer to form a solid layer.

Another object of the present invention is to provide a three-dimensional printer that can overcome the aforesaid drawbacks associated with the prior arts.

Accordingly, one type of a three-dimensional printer of the present invention includes a machine body, a working table, a three-dimensional printing module and a driving module. The machine body is formed with a working space that has an upper end opening. The working table is disposed in the working space, is movable relative to the machine body in a vertical direction, and is adapted to be fed with a powder layer that is adjacent to the upper end opening of the working space. The three-dimensional printing module includes a base seat, a sintering mechanism, a coloring mechanism and a forming mechanism. The base seat is disposed on the machine body and is movable in a horizontal first direction relative to the powder layer. The sintering mechanism is mounted to the base seat, and is adapted to selectively sinter the powder layer to forma sintered layer. The coloring mechanism is mounted to the base seat, is movable in a horizontal second direction relative to the base seat, and is adapted to selectively color the sintered layer to forma sintered and colored layer. The forming mechanism is mounted to the base seat, and is adapted to flatten the sintered and colored layer to form a solid layer. The driving module drives the base seat of the three-dimensional printing module to move in the first direction.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a first preferred embodiment of a three-dimensional printer according to the invention;

FIG. 2 is a perspective view of a three-dimensional printing module of the first preferred embodiment;

FIG. 3 is a fragmentary schematic side view illustrating a feeding mechanism of the first preferred embodiment feeding a powder layer;

FIG. 4 is another fragmentary schematic side view of the first preferred embodiment illustrating the three-dimensional printing module selectively sintering the powder layer;

FIG. 5 is another fragmentary schematic side view of the first preferred embodiment illustrating the feeding mechanism feeding another powder layer above the sintered powder layer;

FIG. 6 is a perspective view of a three-dimensional printing module of a second preferred embodiment of a three-dimensional printer according to the invention;

FIG. 7 is a perspective view of a three-dimensional printing module of a third preferred embodiment of a three-dimensional printer according to the invention; and

FIG. 8 is a cutaway side view of a three-dimensional printing module of a fourth preferred embodiment of a three-dimensional printer according to the invention.

### DETAILED DESCRIPTION OF THE PREFERRED EMBODIMENTS

Before the present invention is described in greater detail, it should be noted that like elements are denoted by the same reference numerals throughout the disclosure.

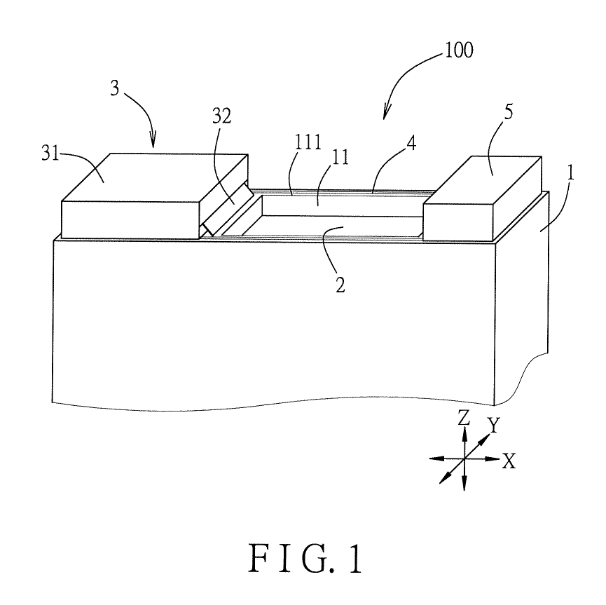

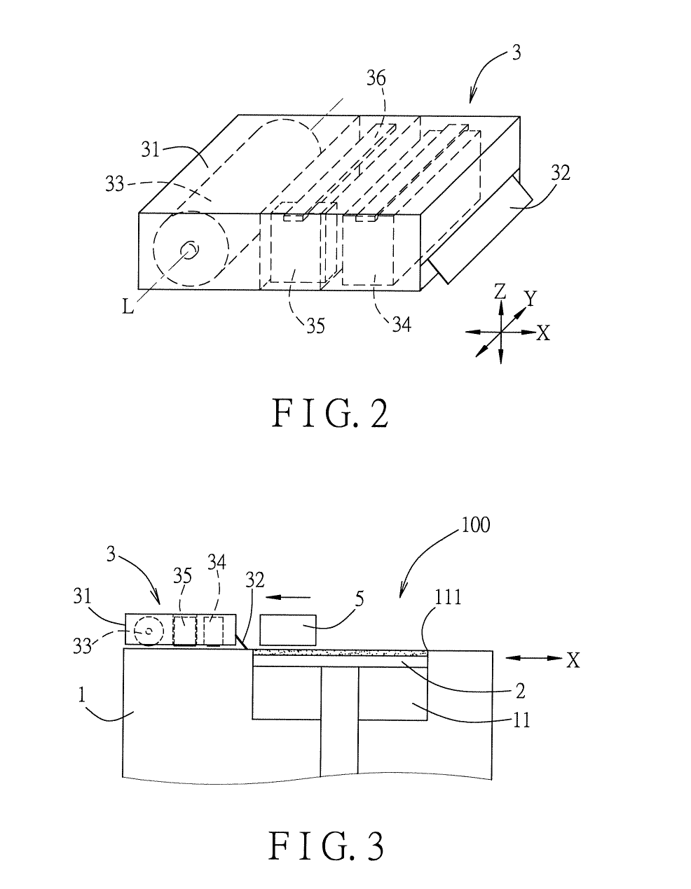

As shown in FIGS. 1 and 2, a first preferred embodiment of a three-dimensional printer 100 according to the present invention includes a machine body 1, a working table 2, a three-dimensional printing module 3, a driving module 4 and a feeding module 5. The machine body 1 is formed with a working space 11 that has an upper end opening 111. The working table 2 is disposed in the working space 11, and is movable relative to the machine body 1 in a vertical direction (Z). The feeding module 5 is disposed on the machine body 1, and is movable relative to the machine body 1 in a horizontal first direction (X) to pass past the upper end opening 111 of the working space 11 to feed a powder layer on the working table 2. The three-dimensional printing module 3 includes abase seat 31 that is disposed on the machine body 1, and that is movable relative to the machine body 1 in the first direction (X) to pass past the upper end opening 111 of the working space 11. The driving module 4 is disposed on the machine body 1 for driving movements of the feeding module 5 and the base seat 31 of the three-dimensional printing module 3.

The three-dimensional printing module 3 further includes a scrape mechanism 32, a forming mechanism 33, a sintering mechanism 34, a coloring mechanism 35 and a driving mechanism 36.

The scrape mechanism 32 is mounted to an outer surface of the base seat 31. In this embodiment, the scrape mechanism 32 is configured as a scraper blade that is driven by the base seat 31 to scrape the powder layer fed on the working table 2 when the base seat 31 moves in the first direction (X).

The forming mechanism 33 is mounted on the base seat 31, and is spaced apart from the scrape mechanism 32 in the first direction (X). In this embodiment, the forming mechanism 33 is configured as a roller that is mounted rotatably on the base seat 31 and that has a rotating axis (L) extending in a horizontal second direction (Y) perpendicular to the first direction (X) The length of the roller 33 is substantially equal to the width of the upper end opening 111 of the working space 11 in the second direction (Y).

The sintering mechanism 34 is mounted on the base seat 31, and is disposed between the scrape mechanism 32 and the forming mechanism 33. In this embodiment, the sintering mechanism is configured as a thermal print head (TPH).

The coloring mechanism 35 is mounted on the base seat 31, and is disposed between the sintering mechanism 34 and the forming mechanism 33. In this embodiment, the coloring mechanism 35 is configured as an inkjet print head assembly that contains dyes having different colors and that is movable relative to the base seat 31 in the second direction (Y).

The driving mechanism 36 is mounted to the base seat 31 for driving the coloring mechanism 35 to move in the second direction (Y). In this embodiment, the driving mechanism 36 includes guide rails and servomotors (not shown) that are mounted to the base seat 31, but is not limited to such a structure.

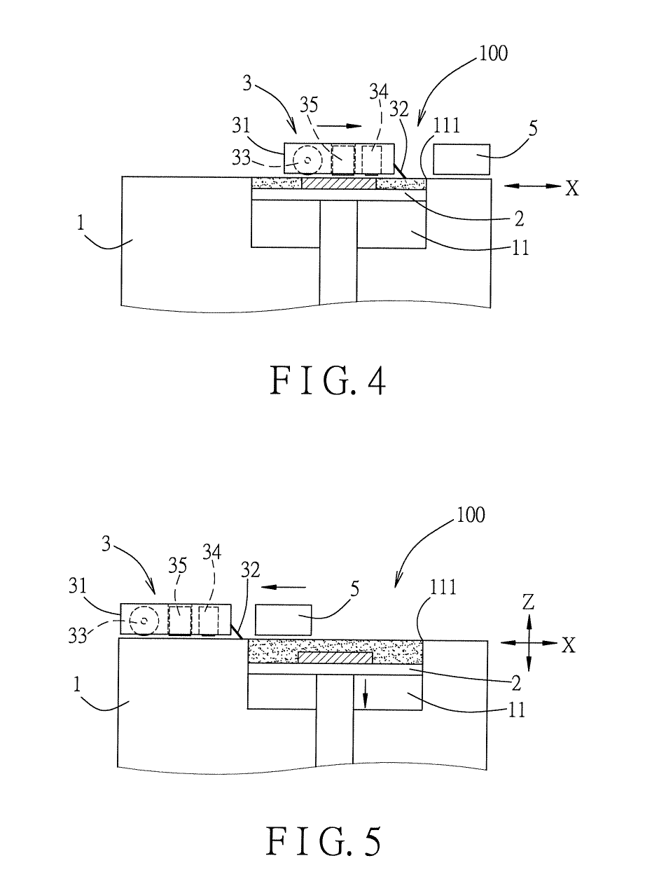

FIGS. 3 and 4 illustrate operation of the first preferred embodiment of the three-dimensional printer 100, wherein the working table 52 is initially disposed adjacent to the upper end opening 111 of the working space 11. The driving module 4 (see FIG. 1) first drives the feeding module 5 to move in the first direction (X) to feed a powder layer on the working table 52. Then, the driving module 4 drives the base seat 31 of the three-dimensional printing module 3 to move relative to the powder layer in the first direction (X) to deal with the powder layer. During the movement of the base seat 31, the scrape mechanism 32 scrapes an upper portion of the powder layer such that the powder layer has a uniform thickness and is suitable for being sintered, the sintering mechanism 34 selectively sinters the powder layer to form a sintered layer that is in a molten state, the coloring mechanism 35 is driven by the driving mechanism 35 to move reciprocally in the second direction (Y) relative to the base seat 31 to apply the dyes having different colors onto the sintered layer to form a sintered and colored layer, and the forming mechanism 33 rolls the sintered and colored layer to flatten and cool the sintered and colored layer down to form a finished layer that includes un-sintered powder and a colored solid model of a first one of a series of successive cross-sections of a three-dimensional CAD model.

Referring to FIG. 5, after the solid model of the first cross-section of the CAD model is formed, the working table 2 is lowered relative to the machine body 1. Afterward, the driving module 4 drives the feeding module 5 to feed another powder layer on the finished layer, and then drives the base seat 31 to move relative to the powder layer, such that the three-dimensional printing module 3 forms another finished layer on the previous finished layer. By performing the abovementioned operations repeatedly, a colored solid model of the CAD model is obtained.

The first preferred embodiment of the three-dimensional printer 100 of this invention applies dyes to a sintered monochromic powder layer to form a colored solid model. It is noted that the molten-state sintered layer is superior to absorb the dyes, so that the quality of the coloration of the first preferred embodiment is better than the conventional three-dimensional printer that applies dyes to a cooled-down sintered solid model.

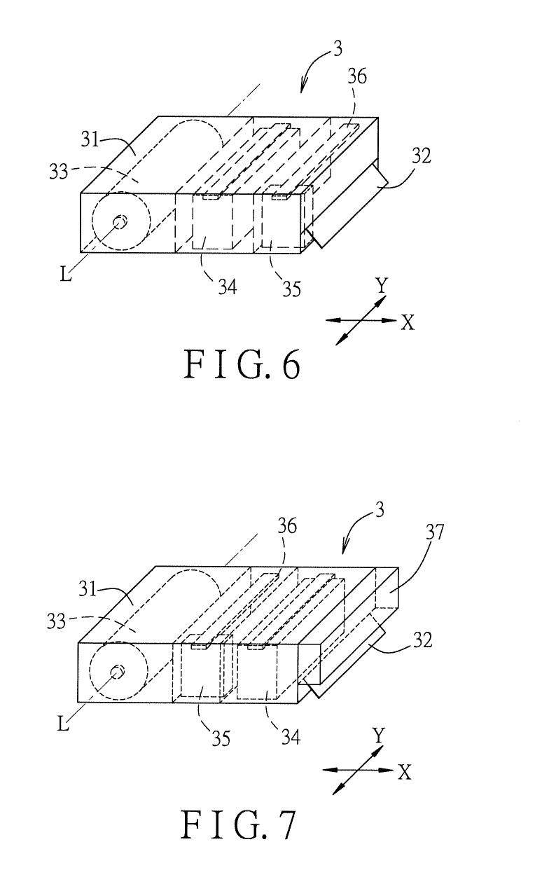

Referring to FIG. 6, a three-dimensional printing module 3 of a second preferred embodiment of the three-dimensional printer 100 according to the present invention is similar to that of the first preferred embodiment. What is different is that the coloring mechanism 35 of the three-dimensional printing module 3 of the second preferred embodiment is disposed between the scrape mechanism 32 and the sintering mechanism 34 to directly apply dyes to the powder layer. The quality of the coloration of the second preferred embodiment is also better than the conventional three-dimensional printer that applies dyes to a cooled-down sintered solid model.

Referring to FIG. 7, a three-dimensional printing module 3 of a third preferred embodiment of the three-dimensional printer 100 according to the present invention is similar to that of the first preferred embodiment. The difference between the first and third preferred embodiments is that the three-dimensional printing module 3 of the third preferred embodiment further includes a feeding mechanism 37 mounted on the base seat 31 and disposed at one side of the scrape mechanism 32 opposite to the sintering mechanism 34 for feeding a powder layer on the working table 2 during the movement of the base seat 31 driven by the driving module 4. With such a configuration, the feeding module 5 of the third preferred embodiment can be omitted. Therefore, the three-dimensional printer 100 of the third preferred embodiment has a smaller dimension and a simplified structure.

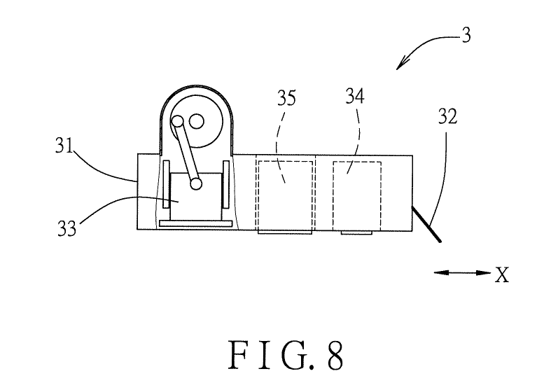

Referring to FIG. 8 a three-dimensional printing module 3 of a fourth preferred embodiment of the three-dimensional printer 100 according to the present invention is similar to that of the first preferred embodiment. The difference between the first and fourth preferred embodiments is that the forming mechanism 33 of the three-dimensional printing module 3 of the third preferred embodiment is configured as a pressing cuboid that is movable relative to the base seat 31. The pressing cuboid is operable to press against the sintered and colored layer to flatten the sintered and colored layer to form the finished layer.

To sum up, the three-dimensional printer 100 of this invention applies dyes to a monochromic powder layer or a sintered monochromic powder layer to forma colored solid model, such that the quality of the coloration of this invention is better than the conventional three-dimensional printer that applies dyes to a cooled-down sintered solid model. Moreover, the feeding module 5 or the feeding mechanism 37 has a structure simpler than that of the conventional three-dimensional printer that feeds thermoplastic powders having different colors to form a colored powder layer.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A three-dimensional printing module comprising:
a base seat movable in a first direction;
a sintering mechanism mounted to said base seat and adapted to selectively sinter a powder layer;
a coloring mechanism mounted to said base seat, movable in a second direction, and adapted to selectively color the powder layer sintered by said sintering mechanism; and
a forming mechanism mounted to said base seat and adapted to flatten the powder layer dealt with by said sintering and coloring mechanisms to forma solid layer.

2. The three-dimensional printing module as claimed in claim 1, wherein the first direction is perpendicular to the second direction.

3. The three-dimensional printing module as claimed in claim 1, further comprising a driving mechanism that is mounted to said base seat for driving said coloring mechanism to move in the second direction relative to said base seat.

4. The three-dimensional printing module as claimed in claim 1, wherein said coloring mechanism is adapted to apply a plurality of dyes having different colors to the powder layer sintered by said sintering mechanism.

5. The three-dimensional printing module as claimed in claim 1, wherein said forming mechanism is configured as a roller.

6. The three-dimensional printing module as claimed in claim 1, wherein said forming mechanism is configured as a pressing cuboid.

7. The three-dimensional printing module as claimed in claim 1, further comprising a feeding mechanism mounted on said base seat and adapted to feed the powder layer.

8. A three-dimensional printer comprising:
a machine body formed with a working space that has an opening;
a working table disposed in said working space, movable relative to said machine body in a vertical direction;
a three-dimensional printing module including
a base seat that is disposed on said machine body and that is movable in a first direction above said opening,
a sintering mechanism that is mounted to said base seat, and that is adapted to selectively sinter a powder layer fed in said working space,
a coloring mechanism that is mounted to said base seat, that is movable in a second direction, and that is adapted to selectively color the powder layer sintered by said sintering mechanism, and
a forming mechanism that is mounted to said base seat, and that is adapted to flatten the powder layer dealt with by said sintering and coloring mechanisms to form a solid layer; and
a driving module for driving said base seat of said three-dimensional printing module to move in the first direction.

9. The three-dimensional printer as claimed in claim 8, further comprising a feeding module disposed on said machine body and movable above said opening for feeding the powder layer in said working space.

10. The three-dimensional printer as claimed in claim 8, wherein said three-dimensional printing module further includes a scrape mechanism that is mounted to an outer surface of said base seat.

11. The three-dimensional printer as claimed in claim 8, wherein said forming mechanism of said three-dimensional printing module is configured as a roller.

12. The three-dimensional printer as claimed in claim 8, wherein said forming mechanism of said three-dimensional printing module is configured as a pressing cuboid.

13. The three-dimensional printer as claimed in claim 8, wherein said three-dimensional printing module further includes a feeding mechanism mounted on said base seat and adapted to feeding the powder layer.
